(19) United States
(12) Patent Application Publication
(10) Pub. No.: US 2007/0159704 A1
(43) Pub. Date: Jul. 12, 2007

(54) OPTICAL SOLAR COLLECTOR

(76) Inventors: HONGCHENG ZHANG, Xiamen (CN); Tianqing Chen, Xiamen (CN); Tianshu Chen, Xiamen (CN); Shuiju Wang, Xiamen (CN)

Correspondence Address: BANGER SHIA, 204 CANYON CREEK, VICTORIA, TX, 77901-3695, US

(21) Appl. No.: 11/620,654

(22) Filed: Jan. 6, 2007

(30) Foreign Application Priority Data
Jan. 6, 2006 (CN) CN200620053534.1

(51) Int. Cl. G02B 5/08

(52) U.S. Cl. 359/850

(57) ABSTRACT

The present invention provides an optical solar collector, in which a couple of opposite spherical or aspheric reflectors coated with specular coating are set upon the optical circuit; wherein the smaller spherical or aspheric reflector is built upon the front of the bigger spherical or aspheric reflector oppositely, and a through-hole is built upon the center of the bigger spherical or aspheric reflector for passing through the light reflected by the smaller spherical or aspheric reflector, and an optical concentrator is located behind the bigger spherical or aspheric reflector aiming to the through-hole to construct an optical system; in said optical system, an aspheric flattening lens is set upon the forest of the optical circuit; said aspheric flattening lens is coated with reflection reducing coating on the surface. Due to applying above-mentioned structure, like building up double spherical or double aspheric reflectors on the optical circuit and an optical concentrator to construct an optical collecting system, so the solar energy can be focused on said optical concentrator through the reflecting by said double spherical or double aspheric reflectors, meanwhile the reflecting coatings coated on the surfaces of said double spherical or double aspheric reflectors can reflect the useful part of the solar light to the optical concentrator, but not the harmful part (such like ultraviolet below 400 nm in wavelength) absorbed completely by it, further to transfer it into disposable energy.

### BACKGROUND OF THE INVENTION

1. Field of the Invention

The present invention relates to an optical system, and more particularly to an optical solar collector.

2. Description of Prior Art

So far, energy lack is a worldwide problem. In accordance with expert's estimation, depending to the requirement of the energy now, the existing energy liking coal, natural gas and so on just only can be used for about 50 years. So, developing other energy beyond the earth, such as efficiently transferring solar energy into disposable energy, is a vital thorny problem facing to experts working in all trade and profession.

### OBJECTS AND SUMMARY OF THE INVENTION

It is therefore a main object of the present invention to provide an optical solar collector used for collecting solar energy by an optical system.

For archiving the goal, the present invention provides an optical solar collector, in which a couple of opposite spherical reflectors coated with specular coating are set upon the optical circuit; wherein the smaller spherical reflector is built upon the front of the bigger one oppositely, and a through-hole is built upon the center of the bigger spherical reflector for passing through the light reflected by the smaller spherical reflector, and an optical concentrator is located behind the bigger spherical reflector aiming to the through-hole to construct an optical system; in said optical system, an aspheric flattening lens is set upon the forest of the optical circuit; said aspheric flattening lens is coated with reflection reducing coating on the surface.

an optical solar collector is provided by the present invention, in which a couple of opposite aspheric reflectors coated with specular coating are set upon the optical circuit; wherein the smaller aspheric reflector is built upon the front of the bigger one oppositely, and a through-hole is built upon the center of the bigger aspheric reflector for passing through the light reflected by the smaller aspheric reflector, and an optical concentrator is located behind the bigger aspheric reflector aiming to the through-hole to construct an optical system; in said optical system, an aspheric flattening lens is set upon the forest of the optical circuit; said aspheric flattening lens is coated with reflection reducing coating on the surface.

an optical solar collector is provided by the present invention, in which a couple of opposite a spherical reflector and an aspheric reflector both coated with specular coating are set upon the optical circuit; wherein the smaller spherical or aspheric reflector is built upon the front of the bigger one oppositely, and a through-hole is built upon the center of the bigger spherical or aspheric reflector for passing through the light reflected by the smaller spherical or aspheric reflector, and an optical concentrator is located behind the bigger spherical or aspheric reflector aiming to the through-hole to construct an optical system; in said optical system, an aspheric flattening lens is set upon the forest of the optical circuit; said aspheric flattening lens is coated with reflection reducing coating on the surface.

Due to applying above-mentioned structure, like building up doable spherical or double aspheric reflectors on the optical circuit and an optical concentrator to construct an optical collecting system, so the solar energy can be focused on said optical concentrator through the reflecting by said double spherical or double aspheric reflectors, meanwhile the reflecting coatings coated on the surfaces of said double spherical or double aspheric reflectors can reflect the useful part of the solar light to the optical concentrator, but not the harmful part (such like ultraviolet below 400 nm in wavelength) absorbed completely by it, further to transfer it into disposable energy.

### BRIEF DESCRIPTION OF t HE DRAWINGS

FIG. 1 is a sectional view showing the optical circuit in the first embodiment of the present invention.

FIG. 2 is a curve chart showing the relationship of the chromatic aberration and the spherical aberration in the first embodiment of the present invention.

FIG. 3 is a diapoint showing the first embodiment of the present invention.

FIG. 4 is a sectional view showing the optical circuit in the second embodiment of the present invention.

FIG. 5 is a curve chart showing the relationship of the chromatic aberration and the spherical aberration in the second embodiment of the present invention.

FIG. 6 is a diapoint showing the second embodiment of the present invention.

FIG. 7 is a sectional view showing the optical circuit in the third embodiment of the present invention.

FIG. 8 is a curve chart showing the relationship of the chromatic aberration arid the spherical aberration in the third embodiment of the present invention.

FIG. 9 is a diapoint showing the third embodiment of the present invention.

FIG. 10 is a sectional view showing the optical circuit in the fourth embodiment of the present invention.

FIG. 11 is a curve chart showing the relationship of the chromatic aberration and the spherical aberration in the fourth embodiment of the present invention.

FIG. 12 is a diapoint showing the fourth embodiment of the present invention.

FIG. 13 is a sectional view showing the optical circuit in the fifth embodiment of the present invention.

FIG. 14 is a curve chart showing the relationship of the chromatic aberration and the spherical aberration in the fifth embodiment of the present invention.

FIG. 15 is a diapoint showing the fifth embodiment of the present invention.

### DETAILED DESCRIPTION OF PREFERRED EMBODIMENTS

Before describing the detail of the embodiments, there are several term conceptions having to be stressed as followings:

Optical aberration: in the optical system the defects of the real image obtained through deflecting or reflecting by optical lens in geometry comparing with the ideal image. The ideal image is an image presented by an ideal optical system. But in real optical system, the image depends to a certain formation space and beam-defining aperture, meanwhile the image beam compositing of different lights with different wave length, and the reflectivity of a same median to different wave-length light also affect the image formation. Therefore there are a serial defects existing in a real optical system, these defects are aberration. The value of the aberration is responded to the quality of the optical system.

Spherical aberration: is an offset in position between a real point obtained by a concentric light beam shot from a point at an axis through deflecting by all reflecting surfaces in the optical system passes through different aperture angle, and an ideal point, said offset is spherical aberration. The difference of the image intercept obtained via the system by a different aperture angle light beam shot from a point on the axis and the image intercept at the nearest axis. The smaller said spherical aberration is, the better the energy evenness degree is, the uniform distribution of light on a chip facilitates to energy collecting.

Chromatic aberration: in optical system the image is formatted by most of white light. Said white light is composed of different wave-length homogeneous beams. The optical material has different chromatic reflectivity for different beams, so the white light is divided into different chromatic beams via deflecting by the first deflecting surface of the optical system, the each chromatic beam can be transmitted via different optical circuit so that the position of imaging and the size of imaging are different between the different chromatic beams, so the image formatted is presented with color blur circle. When the plurality of chromatic beams images, the optical aberration occurred by the different chromatic beams is called as chromatic aberration. The smaller the chromatic aberration is, the better energy is collected.

Diapoint: the optical design must correct the optical aberration of the optical system; since it is impossible to correct the optical aberration into the ideal degree completely, the better project of correcting optical aberration should be selected, and what degree the image correction need to get also should be decided, such as defining to aberration tolerance. The many light beams shot from a point on the axis passing through the optical system are not focused on a same point occurred by the optical aberration with the image surface, but to form a dispersed image in a certain confusion spot, so it is called diapoint. The spot density of the diapoint can be used to measure the quality of the imaging system. The higher the density of spot is, the better collection effect of energy is.

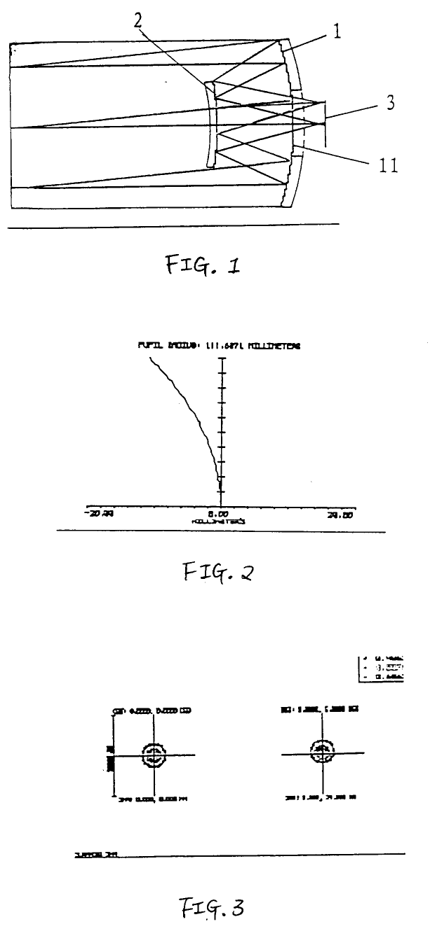

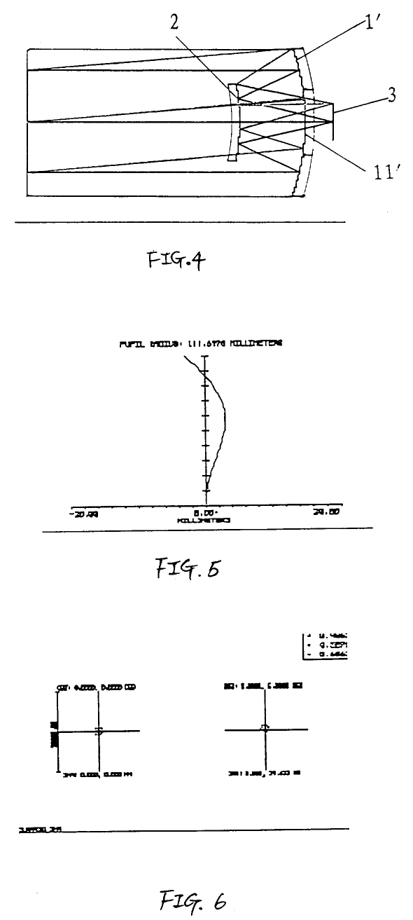

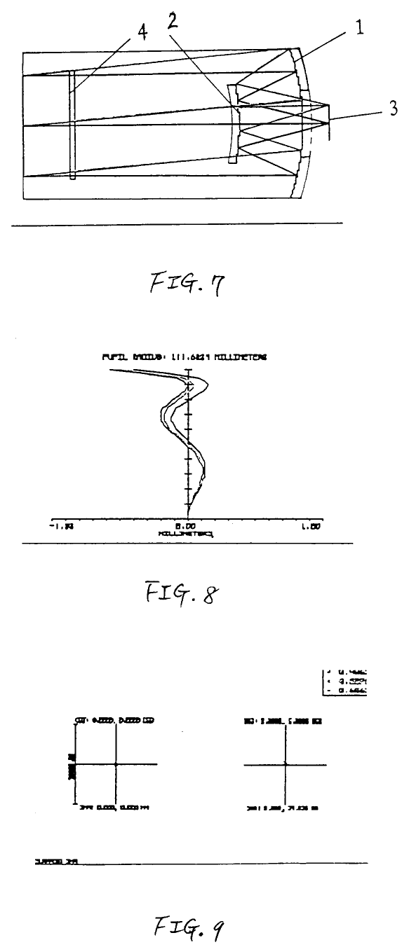

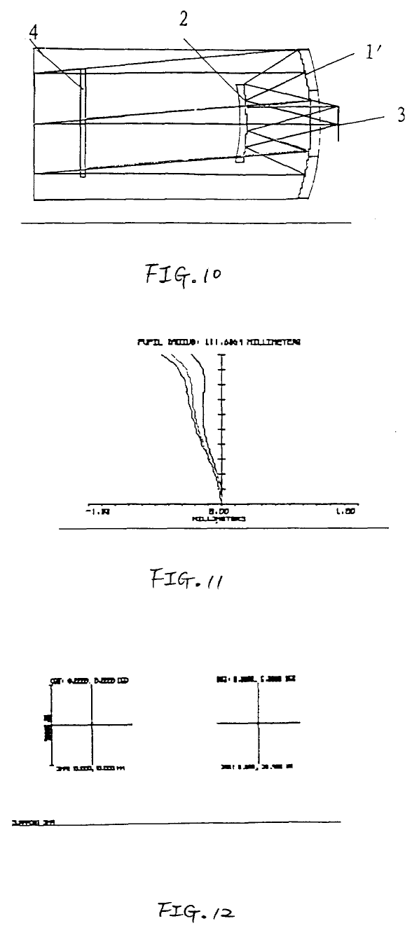

In the first embodiment of the present invention, as shown in FIG. 1 to FIG. 3, an optical solar collector is typically comprised of a bigger spherical reflector 1, a smaller spherical reflector 2 and an optical concentrator 3, wherein the surfaces of said bigger spherical reflector 1 and said smaller spherical reflector 2 are both coated with reflecting coating thereby reflecting the useful part of the solar light to the optical concentrator 3, but not the harmful part (such like ultraviolet below 400 nm in wavelength) absorbed completely by it. Said both bigger and smaller spherical reflectors 12 are located into the light circuit of the sun light, in which the smaller spherical reflector 2 is built upon the front of the bigger one 1 oppositely, and a through-hole 11 is built upon the center of the bigger spherical reflector 1 for passing through the light reflected by the smaller spherical reflector 2, and an optical concentrator 3 is located behind the bigger spherical reflector 1 aiming to the through-hole 11 to construct an optical system.

In this optical system, the optical aberration formatted is −0, the maximum spherical aberration is −10.83, referring to FIG. 2 showing the relationship of the chromatic aberration and the spherical aberration; FIG. 3 is showing the diapoint of the optical system.

In the second embodiment of the present invention, as shown in FIG. 4 to FIG. 6, an optical solar collector is typically comprised of a bigger aspheric reflector 1′, a smaller spherical reflector 2 and an optical concentrator 3, wherein the surfaces of said bigger aspheric reflector 1′ and said smaller spherical reflector 2 are both coated with reflecting coating thereby reflecting the useful part of the solar light to the optical concentrator 3, but not the harmful part (such like ultraviolet below 400 nm in wavelength) absorbed completely by it. Said both bigger aspheric reflector 1′ and smaller spherical reflector 2 are located into the light circuit of the sun light, in which the smaller spherical reflector 2 is built upon the front of the bigger aspheric reflector 1′ oppositely, and a through-hole 11′ is built upon the center of the bigger aspheric reflector 1′ for passing through the light reflected by the smaller spherical reflector 2, and an optical concentrator 3 is located behind the bigger aspheric reflector 1′ aiming to the through-hole 11′ to construct an optical system.

In this optical system, the optical aberration formatted is −0, the maximum spherical aberration is −3.10, referring to FIG. 5 showing the relationship of the chromatic aberration and the spherical aberration; FIG. 6 is showing the diapoint of the optical system.

In the third embodiment of the present invention, as shown in FIG. 7 to FIG. 9, an optical solar collector is typically comprised of a bigger spherical reflector 1, a smaller spherical reflector 2, an optical concentrator 3 and an aspheric flattening lens 4, wherein the surfaces of said bigger spherical reflector 1 and said smaller spherical reflector 2 are both coated with reflecting coating thereby reflecting the useful part of the solar light to the optical concentrator 3, but not the harmful part (such like ultraviolet below 400nm in wavelength) absorbed completely by it. Said both bigger and smaller spherical reflectors 12 are located into the light circuit of the sun light, in which the smaller spherical reflector 2 is built upon the front of the bigger one 1 oppositely, and a through-hole 11 is built upon the center of the bigger spherical reflector 1 for passing through the light reflected by the smaller spherical reflector 2, and an optical concentrator 3 is located behind the bigger spherical reflector 1 aiming to the through-hole 11 to construct an optical system. In said optical system, the aspheric flattening lens 4 is set upon the forest of the optical circuit; said aspheric flattening lens 4 is coated with reflection reducing coating on the surface.

In this optical system, the optical aberration formatted is −0.18, the maximum spherical aberration, is −0.52, referring to FIG. 8 showing the relationship of the chromatic aberration and the spherical aberration; FIG. 9 is showing the diapoint of the optical system.

In the fourth embodiment of the present invention, as shown in FIG. 10 to FIG. 12, an optical solar collector is typically comprised of a bigger aspheric reflector 1′ a smaller spherical reflector 2, an optical concentrator 3 and an aspheric flattening lens 4, wherein the surfaces of said bigger aspheric reflector 1′ and said smaller spherical reflector 2 are both coated with reflecting coating thereby reflecting the useful part of the solar light to the optical concentrator 3, but not the harmful part (such like ultraviolet below 400 nm in wavelength) absorbed completely by it. Said both bigger aspheric reflector 1′ and smaller spherical reflector 2 are located into the light circuit of the sun light, in which the smaller spherical reflector 2 is built upon the front of the bigger aspheric reflector 1′ oppositely, and a through-hole 11′ is built upon the center of the bigger aspheric reflector 1′ for passing through the light reflected by the smaller spherical reflector 2, and an optical concentrator 3 is located behind the bigger aspheric reflector 1′ aiming to the through-hole 11′ to construct an optical system. In said optical system, the aspheric flattening lens 4 is set upon the forest of the optical circuit; said aspheric flattening lens 4 is coated with reflection reducing coating on the surface.

In this optical system, the optical aberration formatted is −0.22, the maximum spherical aberration is −0.038, referring to FIG. 11 showing the relationship of the chromatic aberration and the spherical aberration; FIG. 12 is showing the diapoint of the optical system.

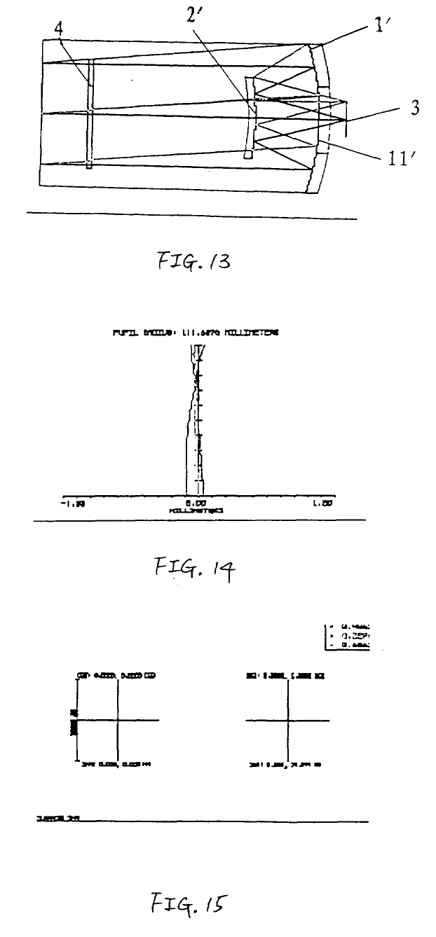

In the fifth embodiment of the present invention, as shown in FIG. 13 to FIG. 15, an optical solar collector is typically comprised of a bigger aspheric reflector 1′, a smaller aspheric reflector 2′, an optical concentrator 3 and an aspheric flattening lens 4, wherein the surfaces of said bigger aspheric reflector 1′ and said smaller aspheric reflector 2′ are both coated with reflecting coating thereby reflecting the useful part of the solar light to the optical concentrator 3, but not the harmful part (such like ultraviolet below 400 nm in wavelength) absorbed completely by it. Said both bigger and smaller aspheric reflectors 1′ 2′ are located into the light circuit of the sun light, in which the smaller aspheric reflector 2′ is built upon the front of the bigger one 1′ oppositely, and a through-hole 11′ is built upon the center of the bigger aspheric reflector 1′ for passing through the light reflected by the smaller aspheric reflector 2′, and an optical concentrator 3 is located behind the bigger aspheric reflector 1′ aiming to the through-hole 11′ to construct an optical system. In said optical system, the aspheric flattening lens 4 is set upon the forest of the optical circuit; said aspheric flattening lens 4 is coated with reflection reducing coating on the surface.

In this optical system, the optical aberration formatted is −0.12, the maximum spherical aberration is −0.029, referring to FIG. 14 showing the relationship of the chromatic aberration and the spherical aberration; FIG. 15 is showing the diapoint of the optical system.

I claim:

1. An optical solar collector, in which a couple of opposite spherical reflectors coated with specular coating are set upon the optical circuit; wherein the smaller spherical reflector is built upon the front of the bigger one oppositely, and a through-hole is built upon the center of the bigger spherical reflector for passing through the light reflected by the smaller spherical reflector, and an optical concentrator is located behind the bigger spherical reflector aiming to the through-hole to construct an optical system; in said optical system, an aspheric flattening lens is set upon the forest of the optical circuit; said aspheric flattening lens is coated with reflection reducing coating on the surface.

2. An optical solar collector, in which a couple of opposite aspheric reflectors coated with specular coating are set upon the optical circuit; wherein the smaller aspheric reflector is built upon the front of the bigger one oppositely, and a through-hole is built upon the center of the bigger aspheric reflector for passing through the light reflected by the smaller aspheric reflector, and an optical concentrator is located behind the bigger aspheric reflector aiming to the through-hole to construct an optical system; in said optical system, an aspheric flattening lens is set upon the forest of the optical circuit; said aspheric flattening lens is coated with reflection reducing coating on the surface.

3. An optical solar collector, in which a couple of opposite a spherical reflector and an aspheric reflector both coated with specular coating are set upon the optical circuit; wherein the smaller spherical or aspheric reflector is built upon the front of the bigger one oppositely, and a through-hole is built upon the center of the bigger spherical or aspheric reflector for passing through the light reflected by the smaller spherical or aspheric reflector, and an optical concentrator is located behind the bigger spherical or aspheric reflector aiming to the through-hole to construct an optical system; in said optical system, an aspheric flattening lens is set upon the forest of the optical circuit; said aspheric flattening lens is coated with reflection reducing coating on the surface.
